(19) United States
(12) Patent Application Publication
(10) Pub. No.: US 2010/0133343 A1
(43) Pub. Date: Jun. 3, 2010

(54) METHOD AND SYSTEM FOR PSEUDO BAR CODE GENERATION

(75) Inventor: Anton Bakker, Norfolk, VA (US)

Correspondence Address: ROBERTS MLOTKOWSKI SAFRAN & COLE, P.C.;Intellectual Property Department, P.O. Box 10064, MCLEAN, VA, 22102-8064, US

(73) Assignee: Outsite Networks, Inc., Norfolk, VA (US)

(21) Appl. No.: 12/420,786

(22) Filed: Apr. 8, 2009

Related U.S. Application Data
(60) Provisional application No. 61/119,409, filed on Dec. 3, 2008.

(51) Int. Cl. G06K 7/10

(52) U.S. Cl. 235/462.01

(57) ABSTRACT

A system, method and computer program product for processing bar codes at point-of-sale (POS) terminals, including a bar code reader or scanner for determining a bar code of an item; a pseudo bar code generator coupled to the bar code reader or scanner and that generates a pseudo bar code based on a received trigger signal; and a POS terminal coupled to the pseudo bar code generator. If the trigger signal is not received, the pseudo bar code generator sends to the POS terminal a bar code determined by the bar code reader or scanner. If the trigger signal is received, the pseudo bar code generator, based on the trigger signal, generates and sends a pseudo bar code the POS terminal. The POS terminal generates a sales slip based on bar codes from the bar code reader or scanner, and pseudo bar codes from the pseudo bar code generator.

### CROSS REFERENCE TO RELATED DOCUMENTS

The present invention claims benefit of priority to U.S. Provisional Patent Application Ser. No. 61/119,409 of Anton BAKKER, entitled “METHOD AND SYSTEM FOR PSEUDO BAR CODE GENERATION,” filed on Dec. 3, 2008, the entire disclosure of which is hereby incorporated by reference herein.

### BACKGROUND OF THE INVENTION

1. Field of the Invention

The present invention generally relates to systems and methods for processing bar codes at point-of-sale (POS) terminals, and more particularly to a system and method for generating and processing pseudo bar codes at point-of-sale (POS) terminals.

2. Discussion of the Background

Bar code readers have been employed for numerous years at point-of-sale (POS) terminals for processing items affixed with bar codes, wherein an item, such as a product to be purchased or a coupon, bearing a bar code is scanned by a bar code reader for processing by the POS terminal for generating a sales receipt for a customer. However, the present bar code systems and methods typically are only configured for processing items that have been pre-affixed with bar codes.

### SUMMARY OF THE INVENTION

Therefore, there is a need for a method and system that addresses the above and other problems with conventional systems and methods for processing bar codes. The above and other problems are addressed by the exemplary embodiments of the present invention, which provide a novel system and method for generating and processing pseudo bar codes at point-of-sale (POS) terminals. For example, based on a signal from a trigger source, a pseudo bar code generator, interposed between a bar code reader and POS terminal, generates a pseudo bar code that is sent to the POS terminal for processing. Advantageously, the pseudo bar code can be configured as an incentive or coupon, as a form of virtual currency, and the like, and processed by the POS terminal along with any other coupons and purchased products for generating a sales receipt.

Accordingly, in exemplary aspects of the present invention there is provided a system, method and computer program product for processing bar codes at point-of-sale (POS) terminals, including a bar code reader or scanner for determining a bar code of an item; a pseudo bar code generator coupled to the bar code reader or scanner and that generates a pseudo bar code based on a received trigger signal; and a POS terminal coupled to the pseudo bar code generator. If the trigger signal is not received, the pseudo bar code generator sends to the POS terminal a bar code determined by the bar code reader or scanner. If the trigger signal is received, the pseudo bar code generator, based on the trigger signal, generates and sends a pseudo bar code the POS terminal. The POS terminal generates a sales slip based on bar codes from the bar code reader or scanner, and pseudo bar codes from the pseudo bar code generator.

Still other aspects, features, and advantages of the present invention are readily apparent from the following detailed description, by illustrating a number of exemplary embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 illustrates an exemplary pseudo bar code generation system; and

FIG. 2 illustrates an exemplary flow chart corresponding to the exemplary pseudo bar code generation system of FIG. 1.

### DETAILED DESCRIPTION OF THE PREFERRED EMBODIMENTS

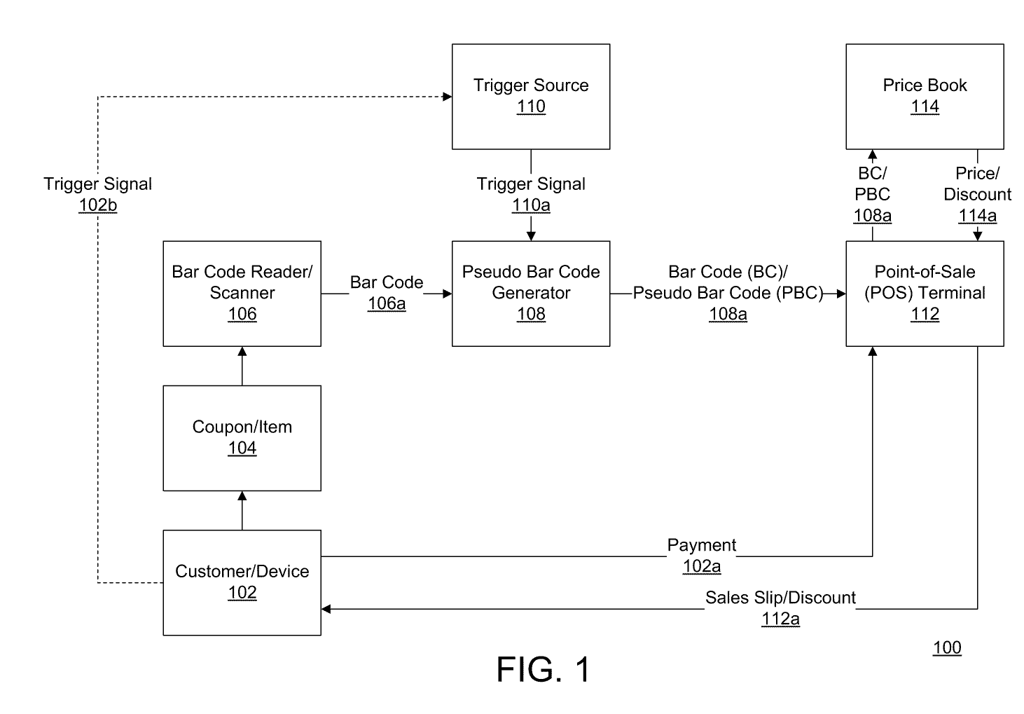

Referring now to the drawings, wherein like reference numerals designate identical or corresponding parts throughout the several views, and more particularly to FIG. 1 thereof, there is illustrated an exemplary pseudo bar code generation system 100. In FIG. 1, the system 100 includes a customer or customer device 102 that presents a coupon or item 104 to a bar code reader or scanner 106. Under normal operation, the bar code reader or scanner 106 reads a bar code (BC) from the coupon or item 104 and sends a corresponding bar code 106a to a pseudo bar code generator 108, which passes the bar code 106a as bar code 108a to a point-of-sale (POS) terminal 112 for generating a sales slip 112a for processing payment 102a from the customer or device 102. The POS terminal 112, based on the received bar code 108a, queries a price book 114 to determine the price or discount 114a corresponding to the item or coupon 104 for generating the sales slip 112a.

If, however, a trigger source 110 generates a trigger signal 110a that is received by the pseudo bar code generator 108, the pseudo bar code generator 108 generates a pseudo bar code (PBC) 108a that also is sent to the POS terminal 112 for processing. The POS terminal 112, based on the received pseudo bar code 108a, queries the price book 114 to determine the action to be performed based on the pseudo bar code 108a. For example, if the pseudo bar code 108a corresponds to a discount, the discount 114a is included along with any other processed items or coupons in the generated sales slip 112a. Similarly, if the if the pseudo bar code 108a corresponds to virtual currency, the amount of such virtual currency is processed as a form of payment, along with any other processed items or coupons in the generated sales slip 112a. For example, if the item 104 presented is soda pop with a price of one dollar ($1.00) and the pseudo bar code 108a corresponds to a virtual 50 cents ($0.50), such information would be reflected in the price book 114, and the resulting sales slip 112a would be for 50 cents ($1.00-$0.50). In a similar manner, the pseudo bar code 108a can be configured as virtual coupons, incentives, and the like.

In further exemplary embodiments, the trigger signal 110a can be generated based on the customer or device 102 or a signal 102b therefrom, for example, based on loyalty or smart cards, biometric information, such as speech, facial, retina, thumbprint, etc., recognition, and the like. Advantageously, the exemplary system 100, due to the pseudo bar code generator 108 interposed between the bar code reader or scanner 106 and the POS terminal 112, requires minimal or minor changes to existing POS systems, as the pseudo bar code generator 108 passes the received bar codes from the bar code reader or scanner 106 in the absence of the trigger signal 110a.

In further exemplary embodiments, the trigger source 110 can be part of a client server system, wherein a client (the device 102) interfaces with a server (the trigger source 110) to determine the corresponding trigger signal 110a for causing the pseudo bar code generator 108 to generate a corresponding pseudo bar code 108a, for example, based on shopping history, demographics, and the like, of the customer or device 102.

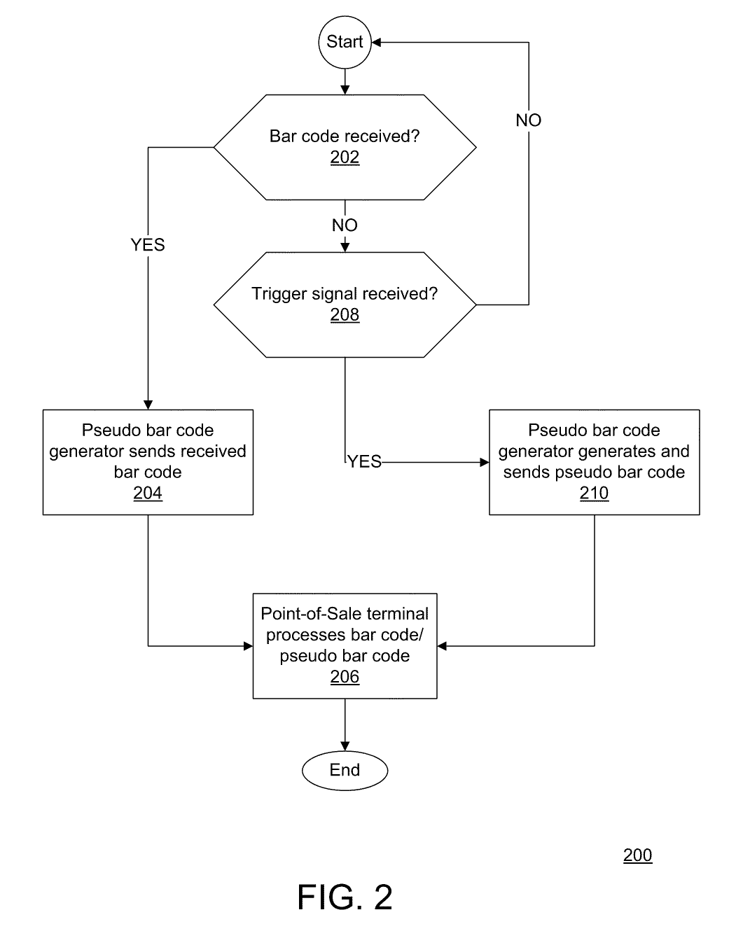

FIG. 2 illustrates an exemplary flow chart 200 corresponding to the exemplary pseudo bar code generation system of FIG. 1. In FIG. 2, at step 202, the pseudo bar code generator 108 determines if a bar code has been received from the bar code reader or scanner 106 and if so at step 204 sends the received bar code to the POS terminal 112 for processing at step 206. If a bar code has not been received from the bar code reader or scanner 106, as determined by step 202, and a trigger signal has not been received from the trigger source 110, as determined by step 208, then the processing is restarted for further downstream processing of bar codes and/or trigger signals. If, however, step 208 determines that a trigger signal has been received from the trigger source 110, the pseudo bar code generator 108 at step 210 generates a corresponding pseudo bar code and sends the generated pseudo bar code to the POS terminal 112 for processing at step 206. In this way, the bar codes and the pseudo bar codes can be processed by the POS terminal 112 for generating a corresponding sales slip.

The above-described devices and subsystems of the exemplary embodiments of FIGS. 1-2 can include, for example, any suitable servers, workstations, PCs, laptop computers, PDAs, Internet appliances, handheld devices, cellular telephones, wireless devices, other devices, and the like, capable of performing the processes of the exemplary embodiments of FIGS. 1-2. The devices and subsystems of the exemplary embodiments of FIGS. 1-2 can communicate with each other using any suitable protocol and can be implemented using one or more programmed computer systems or devices.

One or more interface mechanisms can be used with the exemplary embodiments of FIGS. 1-2, including, for example, Internet access, telecommunications in any suitable form (e.g., voice, modem, and the like), wireless communications media, and the like. For example, the employed communications networks can include one or more wireless communications networks, cellular communications networks, 3G communications networks, Public Switched Telephone Network (PSTNs), Packet Data Networks (PDNs), the Internet, intranets, a combination thereof, and the like. Accordingly, the devices and subsystems of the exemplary embodiments can be implemented on the World Wide Web.

It is to be understood that the devices and subsystems of the exemplary embodiments of FIGS. 1-2 are for exemplary purposes, as many variations of the specific hardware and/or software used to implement the exemplary embodiments are possible, as will be appreciated by those skilled in the relevant art(s). For example, the functionality of one or more of the devices and subsystems of the exemplary embodiments of FIGS. 1-2 can be implemented via one or more programmed computer systems or devices.

To implement such variations as well as other variations, a single computer system can be programmed to perform the special purpose functions of one or more of the devices and subsystems of the exemplary embodiments of FIGS. 1-2. On the other hand, two or more programmed computer systems or devices can be substituted for any one of the devices and subsystems of the exemplary embodiments of FIGS. 1-2. Accordingly, principles and advantages of distributed processing, such as redundancy, replication, and the like, also can be implemented, as desired, to increase the robustness and performance the devices and subsystems of the exemplary embodiments of FIGS. 1-2.

The devices and subsystems of the exemplary embodiments of FIGS. 1-2 can store information relating to various processes described herein. This information can be stored in one or more memories, such as a hard disk, optical disk, magneto-optical disk, RAM, and the like, of the devices and subsystems of the exemplary embodiments of FIGS. 1-2. One or more databases of the devices and subsystems of the exemplary embodiments of FIGS. 1-2 can store the information used to implement the exemplary embodiments of the present invention. The databases can be organized using data structures (e.g., records, tables, arrays, fields, graphs, trees, lists, and the like) included in one or more memories or storage devices listed herein. The processes described with respect to the exemplary embodiments of FIGS. 1-2 can include appropriate data structures for storing data collected and/or generated by the processes of the devices and subsystems of the exemplary embodiments of FIGS. 1-2 in one or more databases thereof.

All or a portion of the devices and subsystems of the exemplary embodiments of FIGS. 1-2 can be conveniently implemented using one or more general purpose computer systems, microprocessors, digital signal processors, micro-controllers, and the like, programmed according to the teachings of the exemplary embodiments of the present invention, as will be appreciated by those skilled in the computer and software arts. Appropriate software can be readily prepared by programmers of ordinary skill based on the teachings of the exemplary embodiments, as will be appreciated by those skilled in the software art. In addition, the devices and subsystems of the exemplary embodiments of FIGS. 1-2 can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or software.

Stored on any one or on a combination of computer readable media, the exemplary embodiments of the present invention can include software for controlling the devices and subsystems of the exemplary embodiments of FIGS. 1-2, for driving the devices and subsystems of the exemplary embodiments of FIGS. 1-2, for enabling the devices and subsystems of the exemplary embodiments of FIGS. 1-2 to interact with a human user, and the like. Such software can include, but is not limited to, device drivers, firmware, operating systems, development tools, applications software, and the like. Such computer readable media further can include the computer program product of an embodiment of the present invention for performing all or a portion (if processing is distributed) of the processing performed in implementing the exemplary embodiments of FIGS. 1-2. Computer code devices of the exemplary embodiments of the present invention can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present invention can be distributed for better performance, reliability, cost, and the like.

As stated above, the devices and subsystems of the exemplary embodiments of FIGS. 1-2 can include computer readable medium or memories for holding instructions programmed according to the teachings of the present invention and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave, or any other suitable medium from which a computer can read.

While the present invention have been described in connection with a number of exemplary embodiments and implementations, the present invention is not so limited, but rather covers various modifications and equivalent arrangements, which fall within the purview of the appended claims.

What is claimed is:

1. A system for processing bar codes at point-of-sale (POS) terminals, the system comprising:
a bar code reader or scanner for determining a bar code contained in an item;
a pseudo bar code generator coupled to the bar code reader or scanner and configured to generate a pseudo bar code based on a received trigger signal;
a point-of-sale terminal coupled to the pseudo bar code generator,
wherein if the trigger signal is not received by the pseudo bar code generator, the pseudo bar code generator is configured to send to the point-of-sale terminal a bar code determined by the bar code reader or scanner,
if the trigger signal is received by the pseudo bar code generator, the pseudo bar code generator is configured to generate, based on the trigger signal, a pseudo bar code and send to the point-of-sale terminal the generated pseudo bar code, and
the point-of-sale terminal is configured to generate a sales slip based on bar codes determined by the bar code reader or scanner, and pseudo bar codes generated by the pseudo bar code generator.

2. A method for processing bar codes at point-of-sale (POS) terminals, the method comprising:
determining by a bar code reader or scanner a bar code contained in an item;
generating a pseudo bar code based on a received trigger signal by a pseudo bar code generator coupled to the bar code reader or scanner, wherein a point-of-sale terminal coupled to the pseudo bar code generator;
if the trigger signal is not received by the pseudo bar code generator, sending by the pseudo bar code generator to the point-of-sale terminal a bar code determined by the bar code reader or scanner;
if the trigger signal is received by the pseudo bar code generator, generating by the pseudo bar code generator, based on the trigger signal, a pseudo bar code, and sending by the pseudo bar code generator to the point-of-sale terminal the generated pseudo bar code; and
generating by the point-of-sale terminal a sales slip, based on bar codes determined by the bar code reader or scanner, and pseudo bar codes generated by the pseudo bar code generator.

3. A computer program product for processing bar codes at point-of-sale (POS) terminals and including one or more computer readable instructions embedded on a computer readable medium and configured to cause one or more computer processors to perform the steps of:
determining by a bar code reader or scanner a bar code contained in an item;
generating a pseudo bar code based on a received trigger signal by a pseudo bar code generator coupled to the bar code reader or scanner, wherein a point-of-sale terminal coupled to the pseudo bar code generator;
if the trigger signal is not received by the pseudo bar code generator, sending by the pseudo bar code generator to the point-of-sale terminal a bar code determined by the bar code reader or scanner;
if the trigger signal is received by the pseudo bar code generator, generating by the pseudo bar code generator, based on the trigger signal, a pseudo bar code, and sending by the pseudo bar code generator to the point-of-sale terminal the generated pseudo bar code; and
generating by the point-of-sale terminal a sales slip, based on bar codes determined by the bar code reader or scanner, and pseudo bar codes generated by the pseudo bar code generator.
